(19) United States
(12) Patent Application Publication
(10) Pub. No.: US 2014/0324982 A1
(43) Pub. Date: Oct. 30, 2014

(54) TOPIC IDENTIFIERS ASSOCIATED WITH GROUP CHATS

(71) Applicant: MICROSOFT CORPORATION, Redmond, WA (US)

(72) Inventors: Rakesh Agrawal, San Jose, CA (US); James A. Cook, Berkeley, CA (US); Krishnaram Kenthapadi, Sunnyvale, CA (US); Nina Mishra, Pleasanton, CA (US)

(73) Assignee: Microsoft Corporation, Redmond, WA (US)

(21) Appl. No.: 13/872,175

(22) Filed: Apr. 29, 2013

(51) Int. Cl. H04L 29/06

(52) U.S. Cl. CPC H04L 65/403
USPC 709/206

(57) ABSTRACT

Text messages over some period of time are collected. Topic identifiers, such as hashtags, are extracted from the text messages. The text messages associated with each topic identifier are processed to identify which topic identifiers are associated with group chats based on information associated with the text messages such as the times when the text messages were generated and whether the text messages identify user accounts. The topic identifiers that are determined to be associated with the group chats are incorporated into applications that allow users to search for group chats, and to view text messages from past group chats.

### BACKGROUND

A group chat is a mass synchronized conversation using a text messaging application such as Twitter™. For example, there currently are group chats related to health issues (diabetes, lupus, weight loss, postpartum depression, etc.), hobbies (movies, wine, skiing, photography, food, sports, cars, etc.), and education (elementary school teachers, college professors, thesis writing, etc.). Typically, participants in a group chat agree on a scheduled start time and end time to generate the text messages related to the group chat, and a topic identifier for the group chat to use (e.g., a hashtag). The participants may then participate in the group chat by following the topic identifier at the scheduled time, and/or generating text messages that include the topic identifier at the scheduled time.

While these group chats are useful for their participants, they may also be relevant or useful to users who have an interest in the topic that is discussed in the chat. For example, a user who is researching a health issue may find the text messages from a group chat related to the health issue useful, or may wish to participate in the next scheduled group chat. In another example, a restaurant may be interested in what users are saying about the restaurant in a group chat related to local restaurants. However, there is no way to both identify group chats and to incorporate information from group chats into search results, making it difficult for interested parties to be made aware of such chats or to make use of information provided in the group chats.

### SUMMARY

Text messages over some period of time are collected. Topic identifiers, such as hashtags, are extracted from the text messages. The text messages associated with each topic identifier are processed to identify which topic identifiers are associated with group chats based on information associated with the text messages such as the times when the text messages were generated and whether the text messages identify user accounts. The topic identifiers that are determined to be associated with the group chats are incorporated into applications that allow users to search for group chats, and to view text messages from past group chats.

In an implementation, a topic identifier is received by a computing device. Text messages associated with the topic identifier are determined by the computing device. Based on the text messages associated with the topic identifier, it is determined if the topic identifier is periodic, synchronous, and cohesive. If so, the topic identifier is associated with a group chat by the computing device.

In an implementation, topic identifiers are received by a computing device. For each topic identifier, messages associated with the topic identifier are retrieved by the computing device. For each topic identifier, whether the topic identifier is periodic is determined based on the retrieved messages associated with the topic identifier by the computing device. For each determined periodic topic identifier, whether the topic identifier is synchronous is determined based on the messages associated with the topic identifier by the computing device. For each determined synchronous topic identifier, whether the topic identifier is cohesive is determined based on the messages associated with the topic identifier by the computing device. For each determined cohesive topic identifier, the topic identifier is associated with a group chat by the computing device. The topic identifiers that are associated with group chats are stored by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for identifying and utilizing group chats;

FIG. 2 is an illustration of an implementation of a system comprising an exemplary group chat engine;

FIG. 3 is an operational flow of an implementation of a method for determining if a topic identifier is associated with a group chat;

FIG. 4 is an operational flow of an implementation of a method for determining topic identifiers that are associated with group chats; and

FIG. 5 shows an exemplary computing environment in which example embodiments and aspects may be implemented.

### DETAILED DESCRIPTION

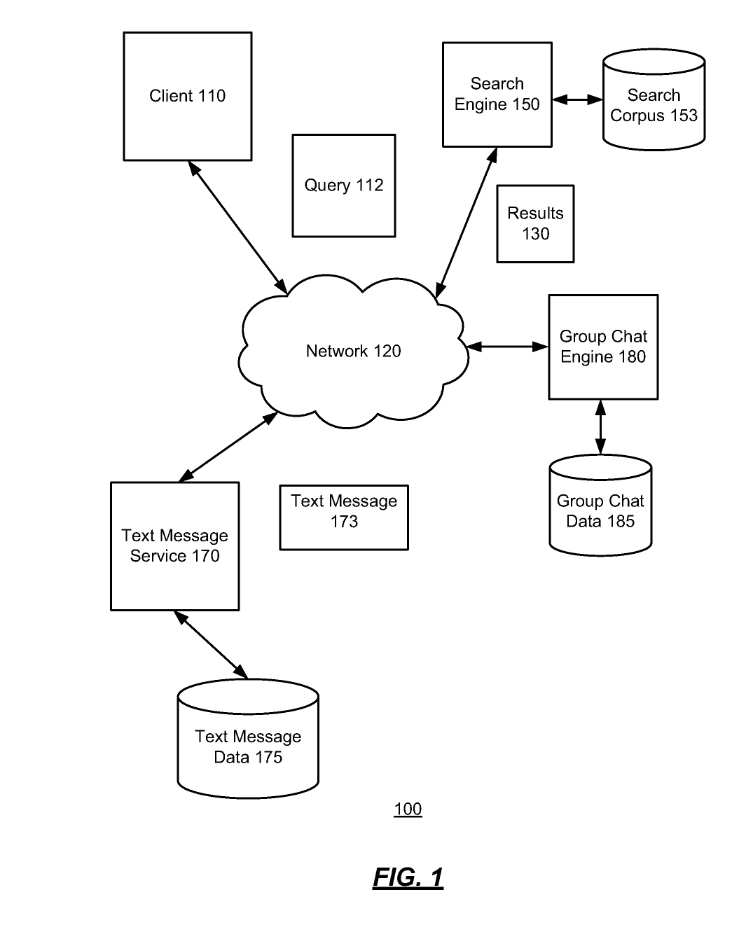

FIG. 1 is an illustration of an exemplary environment 100 for identifying and utilizing group chats. A client 110 may communicate with a search engine 150 or a text message service 170 through a network 120. The client 110 may be configured to communicate with the search engine 150 to access, receive, retrieve, and display media content and other information such as webpages. The network 120 may be a variety of network types including the public switched telephone network (PSTN), a cellular telephone network, and a packet switched network (e.g., the Internet). Although one search engine 150 and text message service 170 is shown in FIG. 1, it is contemplated that the client 110 may be configured to communicate with multiple search engines 150 and/or text message services 170 through the network 120.

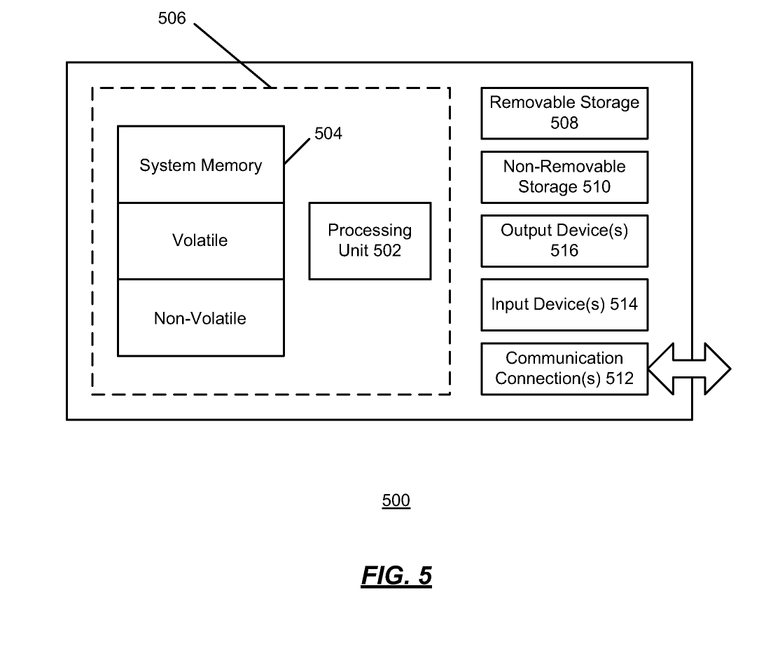

In some implementations, the client 110 may include a desktop personal computer, workstation, laptop, personal digital assistant (PDA), smart phone, cell phone, or any WAP-enabled device or any other computing device capable of interfacing directly or indirectly with the network 120. The client 110 may be implemented using one or more computing devices such as the computing device 500 illustrated in FIG. 5. The client 110 may run an HTTP client, e.g., a browsing program, such as MICROSOFT INTERNET EXPLORER or other browser, or a WAP-enabled browser in the case of a smart phone, cell phone, PDA, or other wireless device, or the like, allowing a user of the client 110 to access, process, and view information and pages available to it from the search engine 150 or the text message service 170. Alternatively or additionally, the client 110 may run a specialized application that accesses information from the search engine 150 or the text message service 170.

The search engine 150 may be configured to provide data relevant to queries 112 received from users using devices such as the client 110. In some implementations, the search engine 150 may receive a query 112 from a user and may fulfill the query using data stored in a search corpus 153. The search corpus 153 may comprise an index of URLs corresponding to webpages along with the text of the webpages or keywords associated with the webpages.

The search engine 150 may fulfill a received query 112 by searching the search corpus 153 for URLs of webpages that are likely to be responsive the query 112. For example, the search engine 150 may match terms of the query 112 with the keywords or text associated with the URLs. Matching URLs may be returned to the user at the client 110 in a webpage as results 130, for example.

The text message service 170 may be configured to provide a text messaging application that allows users to generate text messages 173 using a client 110. Typically each user of the text message service 170 is assigned a user account identifier such as a word, phrase, or number. The user may then use the text message service 170 to send text messages 173 to specific user accounts, or may use the text message service 170 to more broadly publish their text messages 173 where other users can chose to view them. The text messages 173 generated by the text message service 170 may be stored and/or published as text message data 175.

For example, a user may use the text message service 170 to “follow” a particular user account, and receive some or all of the text messages 173 that are generated by the followed user account. In some implementations, users of the text message service 170 may be able to search the text messages 173 generated by users that include specific key words, or that were generated using specific user accounts. An example text message service 170 may include Twitter™ and the text messages 173 may include tweets™. Other text message services 170 and/or text message 173 types may be supported.

Each text message 173 may include some amount of text or characters. Depending on the implementation, the number of characters in each text message 173 may be limited or may be effectively unlimited. For example, in some implementations each text message 173 may be limited to 140 or fewer characters. In addition, each text message 173 may be associated with a time. The time may be the approximate time on which the associated text message 173 was generated or sent. Other types of data may be associated with, or part of a text message 173. For example, text messages 173 may include URLs, images, videos, and other media types.

Each text message 173 may further include what is referred to herein as a topic identifier. A topic identifier may identify a topic, theme, or subject associated with the text message 173 it appears in. Examples of topic identifiers include hashtags. Other types of topic identifiers may be used. A hashtag is a string of characters that begins with the pound sign (“#”). Users may add a topic hashtag to a text message 173 to indicate that it belongs to, or is associated with, the topic or subject associated with the hashtag. Thus, for example, in a text message 173 about their dog's health, a user may add hashtags such as #dog, #pet, #veterinarian, etc.

The text message service 170 may allow users to search the text message data 175 using the topic identifiers. For example, a user may query the text message service 170 for all text messages 173 that include the topic identifier #dog. The text message service 170 may then return all text messages 173 that include the topic identifier #dog. In addition, the text message service 170 may also allow users to follow a particular topic identifier. Continuing the example above, a user may select to follow the topic identifier #dog. When a text message 173 that includes the topic identifier #dog is generated by another user of the text message service 170, the text message 173 is provided to every user that follows the topic identifier #dog.

The use of topic identifiers in text messages 173 may allow users to organize their text messages 173 into what is referred to herein as a group chat. During a group chat, participants in the chat may send and receive text messages 173 that include an agreed upon topic indicator at or around an agreed upon time. Each participant in the chat may then receive each text message 173 that includes the agreed upon topic identifier during the chat, and may respond to one or more of the text messages 173 creating a discussion. Typically, the group chats are held at a regular agreed upon time (e.g., once a week) and last for an agreed upon duration of time (e.g., one hour). In some instances, a group chat may include an agreed upon user to act as a moderator and to highlight particular text messages 173 that include the agreed upon topic identifier for the users of the group chat to discuss. Group chats exist on a variety of topics including entertainment, health, finances, and sports, for example.

Group chats are useful resources for their participants, but may also be useful to a broader class of users. For example, a person who is diagnosed with a type of cancer may benefit from reading text messages 173 from past group chats related to the cancer. In another example, the participants in group chats may be considered experts with respect to the topic of the group chat, and therefore any URLs provided by the participants in the chat may be considered high-quality URLs. The presence of a URL in a group chat may be useful to the search engine 150 when determining how to rank a set of URLs that include the URL. However, while useful, conventionally there is currently no centralized means through which group chats can be discovered or searched. Therefore, a user who may be interested in a topic covered by a group chat conventionally may have to rely on word of mouth to learn of the existence of a particular group chat.

Accordingly, the environment 100 may further include a group chat engine 180. The group chat engine 180 may receive text message data 175 from the text message service 170, and may identify topic identifiers that correspond to group chats. The identified topic identifiers that correspond to group chats, and the text messages 173 that include the identified topic identifiers, may be stored by the group chat engine 180 as the group chat data 185. The group chat data 185 may be used for a variety of group chat related applications, and may be provided to a search engine 150. The group chat data 185 may be used by the search engine 150 to allow users to include group chats in their results 130, and may be used to help rank URLs. In order to ensure the privacy of the user, in some implementations, the text message data 175 associated with a user account may only be provided to the group chat engine 180 if the user associated with the user account opts in or otherwise consents to providing the data.

In some implementations, the group chat engine 180 may further determine a period and duration of each group chat associated with a topic identifier and may include the information with the group chat data 185. The period and duration may be used by the search engine 150, or other application that allows users to search for group chats on a particular subject and determine when the next scheduled group chat may occur. For example, for a group chat that is held weekly from 7 pm to 8:30 pm, the period is weekly and the duration is ninety minutes.

In order to determine whether a topic identifier is a group chat, the properties of a group chat may be first defined. In some implementations, a topic identifier may be considered to correspond to a group chat if the topic identifier is periodic, synchronous, and cohesive. Alternatively, a topic identifier may be considered to correspond to a group chat if the topic identifier is any of periodic, synchronous, or cohesive. Other definitions of group chat may be used by the group chat engine 180.

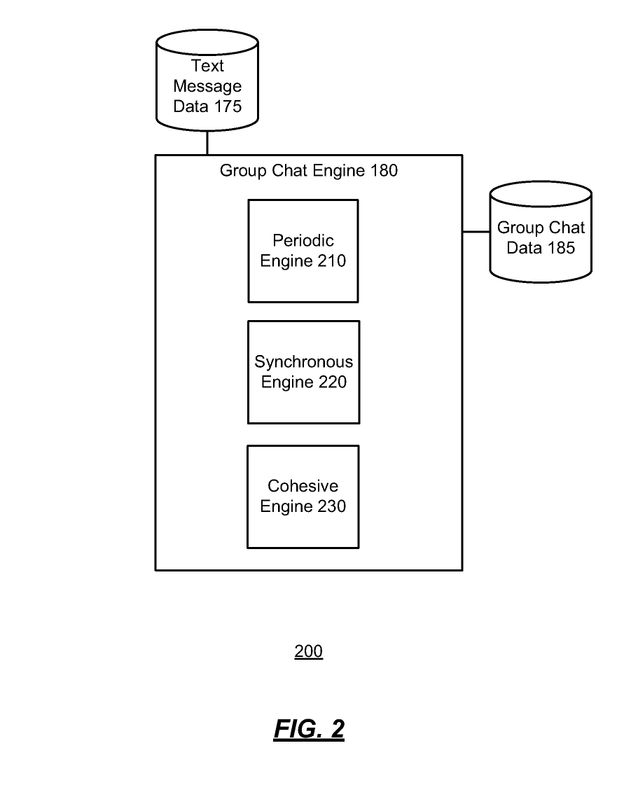

In some implementations, a topic identifier may be periodic if the text messages 173 associated with the topic identifier are generated or sent by users according to a periodic schedule (e.g., every predetermined number of seconds, minutes, hours, etc.). The period may be hourly, daily, weekly, biweekly, monthly, etc. Other periods may be used. As described further with respect to FIG. 2, the group chat engine 180 may determine if the topic identifier is periodic using the times associated with each text message 173 associated with the topic identifier.

In some implementations, a topic identifier may be synchronous if the text messages 173 associated with the topic identifier are generated or sent by users during a duration of time. This duration may be an hour, two hours, three hours, etc. Other durations may be used. For example, for a group chat that has a period of one week and lasts an hour, the duration is one hour. Similarly as the periodic characteristic, the group chat engine 180 may determine if the topic identifier is synchronous using the times associated with each text message 173 associated with the topic identifier.

The synchronous characteristic is to distinguish those topic identifiers that are periodic, but do not otherwise represent group chats. For example, users of a text message service 170 may use topic identifiers that correspond to the day of the week (#monday, #tuesday, #wednesday, etc.) that the text messages 173 are generated. While these topic identifiers are all periodic because they are used once a week, they are not associated with a group chat because they do not facilitate a discussion about a particular topic. Thus, the synchronous characteristic distinguishes these types of topic identifiers because they are each used throughout the entire day and are not synchronized to a particular one or two hour duration. Example details of how the group chat engine 180 may determine whether a topic identifier is synchronous are described further with respect to FIG. 2.

In some implementations, a topic identifier may be cohesive if some predetermined number or fraction of the text messages 173 associated with the topic identifier represent communications between user accounts. For example, the topic identifier may be determined to be cohesive if at least about 20% of the text messages 173 associated with the topic identifier are communications between user accounts. Other percentages may be used. In another example, the topic identifier may be cohesive if a threshold number of user account pairs that use the topic identifier communicated with each other using the topic identifier.

In some implementations, whether or not a topic identifier is cohesive may be determined by first determining the k user accounts that send the most text messages 173 using the topic identifier. In other implementations, the k user accounts may be those who attended the most meetings associated with the topic identifier. These are the top user accounts for the topic identifier. The value of k may be selected by a user or administrator. A count of the number of top user account pairs that exchanged text messages 173 using the topic identifier is then determined. The count may be between 0 and (k*(k−1))/2. If the count is greater than a threshold count, then the topic identifier may be cohesive.

The cohesive characteristic is to further distinguish those topic identifiers that are periodic and synchronous, but do not otherwise represent group chats. For example, users of a text message service 170 may use topic identifiers that correspond to a television program with hope that a producer of the show will select their text message 173 to display during the program. Examples of such topic identifiers include #dwts (for Dancing with the Stars) and #survivor (for Survivor).

While these topic identifiers are periodic because they are used once a week, and synchronous because they are mostly used when the corresponding program is aired, they are not associated with a group chat because they do not facilitate a discussion about the corresponding television shows among the users. Most of the text messages 173 that use such topic identifiers do so to get selected for display during the television program and not to discuss the program. Thus, the cohesive characteristic distinguishes these types of topic identifiers because the text messages 173 that include such topic identifiers are not sent to other user accounts in the text message service 170. Example details of how the group chat engine 180 may determine whether a topic identifier is cohesive are described further with respect to FIG. 2.

FIG. 2 is an illustration of an implementation of an exemplary group chat engine 180. The group chat engine 180 may include several components including, but not limited to, a periodic engine 210, a synchronous engine 220, and a cohesive engine 230. More or fewer components may be supported. The group chat engine 180 may be implemented using one or more computing devices such as the computing device 500 illustrated in FIG. 5.

The periodic engine 210 may receive text message data 175, and based on the text message data 175, may determine one or more topic identifiers that are periodic. As described above, one of the characteristics of a group chat is that it is periodic. In some implementations, the periodic engine 210 may extract the topic identifiers from the text messages 173 that are included in the text message data 175, and may consider whether each extracted topic identifier is periodic. Alternatively, the periodic engine 210 may receive a set of topic identifiers to consider. For example, a user or administrator may preselect a set of topic identifiers that may be associated with group chats, or the set of topic identifiers may be collectively identified.

The periodic engine 210 may, for each topic identifier in the text message data 175, determine if the topic identifier is periodic. The periodic engine 210 may determine if a topic identifier is periodic by retrieving each text message 173 associated with the topic identifier, and may determine if the topic identifier is periodic based on the times associated with each message 173. For example, the periodic engine 210 may look for times where the text messages 173 are clustered or particularly dense, and may determine if the clusters repeat according to any discernable period. Any method for determining a period for a time ordered group of samples may be used.

In some implementations, the periodic engine 210 may determine if a topic identifier h is periodic by generating a timeline function fₕ for the topic identifier h. The periodic engine 210 may generate the timeline function using the times associated with each message 173 associated with the topic identifier. Any system, method, or technique known in the art for generating a timeline function may be used.

The periodic engine 210 may compute a Fourier transform \hat{f} of the timeline function fₕ for a set of candidate frequencies {1/T₁, . . . , 1/Tᵣ} to obtain a Fourier coefficient α for each of the candidate frequencies. The candidate frequencies may be selected by a user or administrator, for example, and may include a large number of typical group chat frequencies. For example, the candidate frequencies may include once a week, twice a week, bi-weekly, monthly, etc. Other frequencies may be used.

In some implementations, the coefficients may be calculated by the periodic engine 210 using formula (1):

\hat{f}(α)=∫f(t)e^{-2πiαt}dt (1)

The periodic engine 210 may further determine an autocorrelation function Ã of the timeline function fₕ for each of a plurality of candidate periods {T₁, . . . , Tᵣ} corresponding to each the candidate frequencies. In some implementations, the periodic engine 210 may determine the autocorrelation function using the formula (2) for a candidate period a:

\tilde{A}(σ)=∫f(t)f(t+σ)dt (2)

The periodic engine 210 may further calculate a periodicity coefficient S(Tₖ) for each of the candidate periods {T₁, . . . , Tᵣ} based on the Fourier transform and the determined autocorrelation. The periodicity coefficient for a candidate period is a measure of how closely the times of the text messages 173 associated with the topic identifier fit the candidate period. A low periodicity coefficient implies that the candidate period does not fit the topic identifier well, and a high periodicity coefficient implies that the candidate period does fit the topic identifier well. Each periodicity coefficient S(Tₖ) for the candidate periods Tₖ may be calculated by the periodic engine 210 using the formula (3), for 1≦k≦r:

$$S ( {T}_{k} ) := \frac{\vert \hat{f} ( 1 / {T}_{k} ) \vert}{\vert \hat{f} ( 0 ) \vert} \cdot \frac{\vert \tilde{A} ( {T}_{k} ) \vert}{\vert \tilde{A} ( 0 ) \vert} \qquad ( 3 )$$

The periodic engine 210 may determine the candidate period with the largest calculated periodicity coefficient as the period for the topic identifier. The periodic engine 210 may compare the largest calculated periodicity coefficient with a threshold periodicity coefficient. If the largest calculated periodicity coefficient is greater than the threshold periodicity coefficient, then the periodic engine 210 may determine that the topic identifier is periodic. The periodic engine 210 may store the period with the largest calculated periodicity coefficient as the period for the topic identifier. The determined period and the topic identifier may be stored by the periodic engine 210 with the group chat data 185.

If the largest calculated periodicity coefficient is not greater than the threshold coefficient, then the periodic engine 210 may determine that the topic identifier is not periodic. The threshold periodicity coefficient may be determined by a user or administrator, for example.

The synchronous engine 220 may determine whether the topic identifiers associated with the text message data 175 are synchronous. As described above, another characteristic of group chats is that they are synchronous. A topic identifier is synchronous if most of the associated text messages 173 occur during a fixed duration at some offset of the determined period. Thus, for example, a topic identifier is synchronous if most of the text messages 173 occur during a one hour duration starting at 7 pm every week.

The synchronous engine 220 may determine whether the topic identifiers that have already been determined to be periodic by the periodic engine 210 are synchronous. Alternatively, the synchronous engine 220 may determine whether topic identifiers are synchronous independently of the periodic engine 210.

The synchronous engine 220 may determine if a topic identifier is synchronous using the determined period for the topic identifier and the time associated with each text message 173 that uses the topic identifier. In some implementations, the synchronous engine 220 may determine if there is duration of time that includes most of the text messages 173 with respect to the determined period. The synchronous engine 220 may consider several possible candidate durations (e.g., one hour, two hours, three hours, etc.) until a duration is determined that includes most of the generated text messages 173. If a suitable duration is determined by the synchronous engine 220, the duration may be stored by the synchronous engine 220 with the topic identifier in the group chat data 185.

In some implementations, the synchronous engine 220 may determine if a topic identifier is synchronous using the timeline function generated by the periodic engine 210 for the topic identifier and the determined period τ for the topic identifier. In addition, the synchronous engine 220 may further make the determination using a synchronization threshold λ and a maximum group chat duration L.

The maximum group chat duration L may be the maximum duration of time for a topic identifier to have and still be considered synchronous. In an implementation, most group chats are around an hour in duration. Thus, if a particular topic identifier has a determined duration of six hours, it may be synchronous, but because its duration is so large it may not be associated with a group chat. For example, the topic identifier #monday has a duration of twenty-four hours, but is not a group chat. The maximum group chat duration L may be selected by a user or administrator.

The synchronization threshold λ may be the minimum percentage of the text messages 173 associated with a topic identifier that may occur during a candidate duration for the topic identifier to be considered synchronous by the synchronous engine 220. While most text messages 173 for group chats occur during the duration associated with the group chat, some number of participants may either begin generating text messages 173 using the topic identifier before the scheduled time of the group chat, or may continue using the topic identifier for some amount of time after the group chat has ended. Thus, the synchronization threshold λ may be selected to account for some amount of use of the topic identifier outside of the duration of the group chat. The synchronization threshold λ may be selected by a user of administrator.

The synchronous engine 220 may determine if the topic identifier is synchronous using a compressed version of the timeline function fₕ determined by the periodic engine 210. The compressed function gₕ may span one period τ determined for the topic identifier by the periodic engine 210. In some implementations, the compressed function gₕ may be defined by formula (4) where t is defined as an offset between 0 and the period τ and T refers to the largest possible timestamp associated with a message:

$${g}_{h} ( t ) := {\sum }_{0 \leq i \leq ⌊ \frac{T}{τ} ⌋}^{ } {f}_{h} ( t + i \cdot τ ) \qquad ( 4 )$$

The synchronous engine 220 may further generate a score for each of a plurality of candidate durations for the topic identifier using the compressed function gₕ. Each candidate duration may be selected based on the maximum group chat duration L and some predetermined increment value. For example, for an increment value of thirty minutes and a maximum group chat duration L of three hours, the synchronous engine 220 may consider candidate durations of a half hour, one hour, one and a half hours, two hours, two and a half hours, and three hours. The increment value may be selected by a user or administrator, for example.

The synchronous engine 220 may determine a score for a candidate duration by determining a count of the number of text messages 173 that are associated with a time that falls within the candidate duration of the determined period for the topic identifier using the compressed timeline function gₕ. The count may be compared with the total number of text messages 173 associated with the topic identifier to generate a score based on the ratio of the count to the total number of text messages 173 associated with the topic identifier.

In some implementations, the score B for a candidate duration may be determined using formula (5) where t is defined as an offset between 0 and the period τ, z is the candidate duration, and α is the total number of messages associated with a topic identifier:

$$B ( t ) := \frac{1}{α} \cdot {\sum }_{0 \leq z \leq L}^{ } {g}_{h} ( ( t + z ) mod τ ) \qquad ( 5 )$$

The synchronous engine 220 may select the candidate duration with the greatest generated score. The synchronous engine 220 may compare the greatest generated score with the synchronization threshold λ. If the greatest generated score is greater than the synchronization threshold λ, then the synchronous engine 220 may determine that the topic identifier is synchronous. The determined duration may then be associated with the topic identifier in the group chat data 185.

The cohesive engine 230 may determine whether the topic identifiers associated with the text message data 175 are cohesive. As described above, another characteristic of group chats is that they are cohesive. A topic identifier is cohesive if some number or percentage of the text messages 173 that include the topic identifier are text messages 173 that are sent between user accounts. A distinguishing feature of group chats is that they are used to facilitate discussion among users. Therefore, a greater number of the text messages 173 that are associated with a group chat are likely to be addressed to particular user accounts associated with the group chat (such as a moderator or other user accounts) than for text messages 173 that are not associated with a group chat.

The cohesive engine 230 may determine whether the topic identifiers that have already been determined to be periodic by the periodic engine 210 and synchronous by the synchronous engine 220 are cohesive. Alternatively, the cohesive engine 230 may determine whether topic identifiers are cohesive independently of either the periodic engine 210 or the synchronous engine 220.

In some implementations, the cohesive engine 230 may determine a topic identifier is cohesive based on a number of user account pairs that exchange text messages 173 associated with the topic identifier. The number of user account pairs may be compared with a threshold number to determine if the topic identifier is cohesive. The threshold number may be set by a user or administrator, and may be based on the number of text messages 173 associated with the topic identifier and/or the number of user accounts that use the topic identifier. Other methods for determining whether a topic identifier is cohesive may be used.

If the cohesive engine 230 determines that topic identifier is cohesive, then the topic identifier may be stored in the group chat data 185. The topic identifiers that were determined to be periodic, synchronous, and cohesive may be identified as group chats in the group chat data 185. As described further below, the group chat engine 180 may use the topic identifiers identified as group chats to provide a variety of services and applications.

In some implementations, the group chat engine 180 may provide an application that allows a user of a client 110 to identify and explore the topic identifiers that have been determined to be group chats. In one example of such a system, a user may search for topic identifiers of group chats that match an interest of the user. The group chat engine 180 may determine matching topic identifiers, and provide the matching topic identifiers to the user. The user may select one of the matching topic identifiers and the group chat engine 180 may use the group chat data 185 and/or the text message data 175 to provide a variety of information related to the matching topic identifier such as the timeline of the text messages 173 associated with the topic identifier, a list of the user accounts in the text message service 170 that participated in the group chat associated with the topic identifier, a time for the next scheduled group chat, and URLs or other information that have been included in the text messages 173 associated with the topic identifier. The group chat engine 180 may further allow a user to view and/or search the text messages 173 associated with the selected topic identifier. The text messages 173 may be provided through an interface associated with an application (such as a smart phone application) or integrated into the search engine 150.

In another example, the group chat engine 180 may provide an application that allows users or companies to derive value from the contents of the text messages 173 associated with the group chats. Because the users that participate in group chats are often particularly interested and/or knowledgeable regarding the topics associated with the group chats, the information provided in the chats may be valuable to certain users or companies also associated with the topics. For example, a company that makes diapers may be interested in what is written by users participating in a group chat associated with parenting. The group chat engine 180 may use the text message data 175 and/or the group chat data 185 to identify the diaper brands that are discussed in the group chat, and may provide indicators of the discussed diaper brands and some or all of the text messages 173 related to the discussion. This information can then be used by the companies to identify strengths or weaknesses associated with their products, and to identify unmet needs or trends for future products. Companies may weight text messages 173 that are associated with group chats higher than text messages 173 that are not associated with group chats when determining the sentiment of the company's brands, products, ads, or overall perception of the company.

Similarly, companies may use the group chats to analyze different segments associated with the company or products. For example, a company that makes a computer may determine what parents think of the computer by analyzing text messages 173 discussing the computer that are associated with a group chat used by mothers, and may determine what college students think of the computer by analyzing text messages 173 discussing the computer that are associated with a group chat used by college students. In another example, the company that makes the computer may determine what fans of a competitor think of the computer by analyzing text messages 173 discussing the computer that are associated with a group chat used by fans of the competitor.

In addition, the group chat engine 180 may identify user accounts that are taste makers or highly regarded in the group chats to companies. The group chat engine 180 may analyze the text messages 173 associated with a particular group chat and identify the user accounts associated with the largest number of text messages 173 as important to the group chat. Companies may then reach out to the users associated with the identified user accounts to evaluate and/or promote new products.

In some implementations, the text message data 175 and/or the group chat data 185 may be provided to the search engine 150. The search engine 150 may utilize the group chat data 185 and/or the text message data 175 when generating results 130 in response to a query 112. For example, when a query 112 is received, the search engine 150 may determine if any of the topic identifiers that were determined to be group chats match or are relevant to the query 112. If so, the determined topic identifiers may then be incorporated into the results 130, along with a next scheduled time for the group chat associated with each topic identifier. In addition, some or all of the text messages 173 associated with each topic identifier may be incorporated into the results 130.

In another example, the search engine 150 may incorporate the text message data 175 and/or the group chat data 185 into the search experience provided in the results 130. Typically, when the search engine 150 selects matching URLs from the search corpus 153 in response to a query 112, the search engine 150 uses a ranking algorithm to rank the large number of matching URLs. Because participants in group chats are generally considered to be trustworthy, the URLs that are provided during group chats may be considered high-quality URLs. Accordingly, URLs that match a query 112 and were provided in a group chat may be weighted higher than URLs that were not provided in a group chat. Other types of ranking techniques may be used.

In another example, the search engine 150 may provide an “expert user” search, or may identify expert users in results 130. For example, a user may provide a query 112 or request looking for experts related to health. The search engine 150 may use the group chat data 185 to determine topic identifiers associated with group chats that are health related. The search engine 150 may identify user accounts of the text message service 170 that are associated with a large number of text messages 173 that included the determined topic identifiers. Any user accounts that are associated with more than a threshold number of user accounts may be presented to the user as possible health experts in response to the query 112.

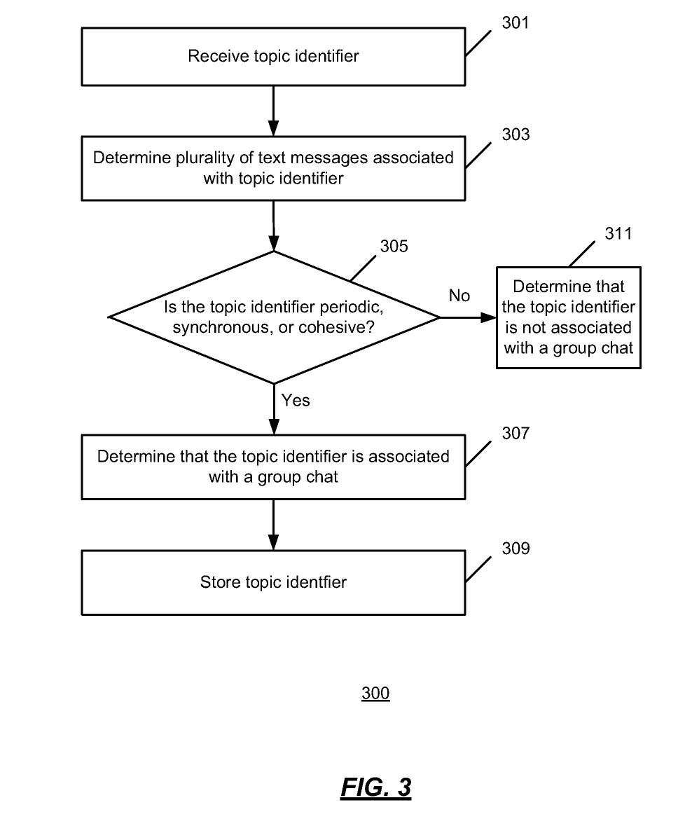

FIG. 3 is an operational flow of an implementation of a method 300 for determining if a topic identifier is associated with a group chat. The method 300 may be implemented by the group chat engine 180, for example.

A topic identifier is received at 301. The topic identifier may be received by the group chat engine 180. The topic identifier may be a hashtag. A plurality of text messages that is associated with the topic identifier is determined at 303. The plurality of text messages 173 associated with the topic identifier may be determined by the group chat engine 180 by determining text messages 173 that include the topic identifier.

Whether the topic identifier is one or more of periodic, synchronous, or cohesive is determined at 305. Whether the topic identifier is periodic, synchronous, or cohesive may be determined using the text messages 173 associated with the topic identifier by the group chat engine 180. Whether the topic identifier is periodic may be determined by the periodic engine 210 of the group chat engine 180. Whether the topic identifier is synchronous may be determined by the synchronous engine 220 of the group chat engine 180. Whether the topic identifier is cohesive may be determined by the cohesive engine 230 of the group chat engine 180. If the topic identifier is determined to be periodic, synchronous, or cohesive then the method 300 may continue at 307. Otherwise, the method 300 may determine that the topic identifier is not associated with a group chat and may exit at 311.

A determination is made that the topic identifier is associated with a group chat at 307. As described above, a group chat has the characteristics of being one or more of periodic, synchronous, and cohesive. Thus, if the text messages 173 associated with a topic identifier also are one or more of periodic, synchronous, or cohesive, then the topic identifier is likely to also be associated with a group chat.

The topic identifier is stored at 309. The topic identifier may be stored by the group chat engine 180 in the group chat data 185 or other storage. In addition, a period and/or duration associated with the topic identifier may be stored in the group chat data 185 or other storage. The group chat data 185 may then be integrated into an application that allows users to search for and view text messages 173 associated with topic identifiers that are group chats. In another implementation, the group chat data 185 may be provided to the search engine 150 and may be incorporated into results 130 and/or used by the search engine 150 to rank URLs in the results 130.

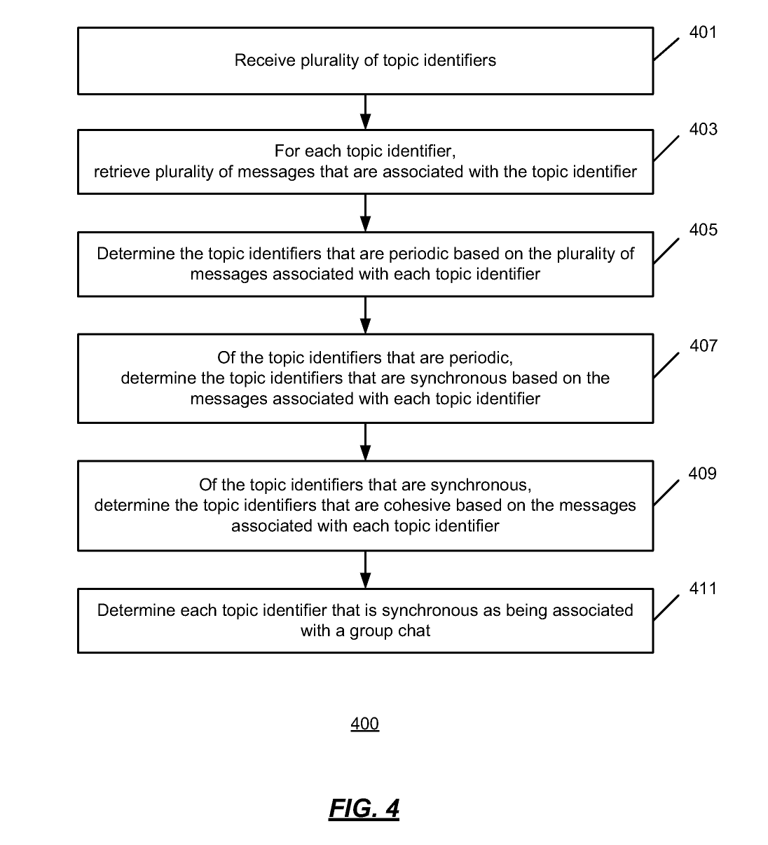

FIG. 4 is an operational flow of an implementation of a method 400 for determining topic identifiers that are associated with group chats. The method 400 may be implemented using the group chat engine 180, for example.

A plurality of topic identifiers is received at 401. The plurality of topic identifiers may be received by the group chat engine 180 from the text message service 170. Alternatively, the topic identifiers may be extracted from text messages 173 by the group chat engine 180. The topic identifiers may comprise hashtags. Other types of topic identifiers may be used.

For each topic identifier, a plurality of messages that are associated with the topic identifier is determined at 403. The plurality of messages may be determined for each topic identifier by the group chat engine 180 by searching for text messages 173 that include the topic identifier.

The topic identifiers that are periodic are determined based on the plurality of messages associated with each topic identifier at 405. The topic identifiers that are periodic may be determined by the periodic engine 210 of the group chat engine 180.

In some implementations, each message may be associated with a time, and the periodic engine may determine that a topic identifier is periodic by receiving a plurality of candidate periods, and determining a periodicity coefficient for each candidate period based on the times associated with each of the plurality of messages associated with the topic identifier. If a greatest periodicity coefficient of the determined periodicity coefficients is greater than a threshold periodicity coefficient, then the periodic engine 210 may determine that the topic identifier is periodic. The periodic engine 210 may further determine the candidate period associated with the greatest periodicity coefficient as the period for the topic identifier.

The periodic topic identifiers that are synchronous are determined based on the plurality of messages associated with each topic identifier at 407. The topic identifiers that are periodic and synchronous may be determined by the synchronous engine 220 of the group chat engine 180.

In some implementations, the synchronous engine 220 may determine that a topic identifier is synchronous by receiving a plurality of candidate durations, and determining a score for each of the candidate durations based on the times associated with each of the plurality of messages associated with the topic identifier and the period of the topic identifier. If a greatest score of the determined scores is greater than a synchronization threshold, then the synchronous engine 220 may determine that the topic identifier is synchronous. The synchronous engine 220 may further determine the candidate duration associated with the greatest score as the duration for the topic identifier.

The synchronous topic identifiers that are cohesive are determined based on the plurality of messages associated with each topic identifier at 409. The topic identifiers that are periodic, synchronous, and cohesive may be determined by the cohesive engine 230 of the group chat engine 180.

In some implementations, the cohesive engine 230 may determine that a topic identifier is cohesive by determining a number of user account pairs that exchanged text messages of the plurality of text messages associated with the topic identifier, and determining if the number is greater than a threshold. If the number of user account pairs is above the threshold, the cohesive engine 230 may determine that the topic identifier is cohesive. A pair of user accounts exchanged a message if either of the user accounts generated a text message 173 that was addressed to the other user account.

Each of the determined periodic, synchronous, and cohesive topic identifiers are determined to be associated with a group chat at 411, and may be stored in storage for example. The determination may be made by the group chat engine 180. In some implementations, the group chat engine 180 may store each topic identifier along with the period and duration determined for the topic identifier with the group chat data 185.

FIG. 5 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by the device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a topic identifier by a computing device;
determining a plurality of text messages associated with the topic identifier by the computing device; and
based on the plurality of text messages associated with the topic identifier, determining if the topic identifier is a group chat by the computing device.

2. The method of claim 1, wherein the topic identifier comprises a hashtag.

3. The method of claim 1, wherein each of the plurality of text messages is associated with a user account, and further comprising:
receiving a request for an expert related to the topic identifier;
determining at least one user account associated with the text messages of the plurality of text messages; and
providing an identifier of the at least one user account as the expert related to the topic identifier.

4. The method of claim 3, wherein determining at least one user account associated with the messages of the plurality of text messages comprises:
receiving a threshold; and
determining at least one user account that is associated with more text messages from the plurality of text messages than the received threshold.

5. The method of claim 1, wherein determining if the topic identifier is a group chat comprises determining if the topic identifier is one or more of periodic, synchronous, or cohesive, and if so, determining that the topic identifier is a group chat.

6. The method of claim 5, wherein each text message of the plurality of text messages is associated with a user account of a plurality of user accounts, and wherein determining if the topic identifier is cohesive comprises:
determining a number of user account pairs of the plurality of user accounts that exchanged text messages of the plurality of text messages associated with the topic identifier;
determining if the number is greater than a threshold; and
if so, determining that the topic identifier is cohesive.

7. The method of claim 5, wherein each text message of the plurality of text messages is associated with a time, and wherein determining if the topic identifier is periodic comprises:
receiving a plurality of candidate periods;
determining a periodicity coefficient for each candidate period based on the times associated with each of the plurality of text messages;
determining if a greatest periodicity coefficient of the determined periodicity coefficients is greater than a threshold periodicity coefficient; and
if so, determining that the topic identifier is periodic.

8. The method of claim 7, further comprising determining the candidate period associated with the greatest periodicity coefficient as a period for the topic identifier.

9. The method of claim 8, wherein determining if the topic identifier is synchronous comprises:
receiving a plurality of candidate durations;
determining a score for each of the candidate durations based on the times associated with each of the plurality of text messages and the period of the topic identifier;
determining if a greatest score of the determined scores is greater than a synchronization threshold; and
if so, determining that the topic identifier is synchronous.

10. The method of claim 9, further comprising determining the candidate duration associated with the greatest score as a duration for the topic identifier.

11. A method comprising:
receiving a plurality of topic identifiers by a computing device;
for each topic identifier, retrieving a plurality of text messages associated with the topic identifier by the computing device;
for each topic identifier, determining if the topic identifier is periodic based on the plurality of text messages associated with the topic identifier by the computing device;
for each determined periodic topic identifier, determining if the topic identifier is synchronous based on the plurality of text messages associated with the topic identifier by the computing device;
for each determined synchronous topic identifier, determining if the topic identifier is cohesive based on the plurality of text messages associated with the topic identifier by the computing device;
for each determined cohesive topic identifier, determining that the topic identifier is associated with a group chat by the computing device; and
storing topic identifiers that are associated with group chats by the computing device.

12. The method of claim 11, wherein each text message is associated with a time, and further wherein determining if the topic identifier is periodic based on the plurality of text messages associated with the topic identifier comprises:
receiving a plurality of candidate periods;
determining a periodicity coefficient for each candidate period based on the times associated with each of the plurality of text messages associated with the topic identifier;
determining if a maximum periodicity coefficient of the determined periodicity coefficients is greater than a threshold periodicity coefficient; and
if so, determining that the topic identifier is periodic.

13. The method of claim 12, further comprising determining the candidate period associated with the maximum periodicity coefficient as a period for the topic identifier.

14. The method of claim 13, wherein determining if the topic identifier is synchronous based on the plurality of text messages associated with the topic identifier comprises:
receiving a plurality of candidate durations;
determining a score for each of the candidate durations based on the times associated with each of the plurality of text messages associated with the topic identifier and the period of the topic identifier;
determining if a greatest score of the determined scores is greater than a synchronization threshold; and
if so, determining that the topic identifier is synchronous.

15. The method of claim 11, wherein each text message is associated with a user account of a plurality of user accounts, and determining if the topic identifier is cohesive based on the plurality of text messages associated with the topic identifier comprises:
determining a number of user account pairs of the plurality of user accounts that exchanged text messages of the plurality of text messages associated with the topic identifier;
determining if the number is greater than a threshold; and
if so, determining that the topic identifier is cohesive.

16. The method of claim 11, further comprising using the stored topic identifiers that are associated with group chats for one or more of ranking URLS, determining expert users, and determining relevant topic identifiers in response to queries.

17. The method of claim 11, further comprising providing an interface through which the stored topic identifiers can be viewed or searched.

18. The method of claim 17, wherein the interface is part of one or more of a search engine or a smart phone application.

19. A system comprising:
a computing device; and
a group chat engine adapted to:
receive a plurality of text messages;
determine a plurality of topic identifiers from the received text messages, wherein each topic identifier is associated with a subset of the text messages of the plurality of text messages;
for each topic identifier, determine if the topic identifier associated with a group chat based on the subset of the plurality of text messages associated with the topic identifier; and
store the topic identifiers that are associated with group chats.

20. The system of claim 19, wherein the group chat engine adapted to determine if a topic identifier is associated with a group chat comprises the group chat engine further adapted to determine if the topic identifier is one or more of periodic, synchronous, or cohesive, and if so, determine that the topic identifier is associated with a group chat.
